(19) United States
(12) Patent Application Publication
(10) Pub. No.: US 2002/0129663 A1
(43) Pub. Date: Sep. 19, 2002

(54) Electronic drink-o-meter (DOM) to monitor fluid intake and provide fluid consumption guidance

(76) Inventors: Reed W. Hoyt, Framingham, MA (US); John F. Lanza, Natick, MA (US)

Correspondence Address: Office of the Staff Judge Advocate, U.S. Army Medical Research and Materiel Command, Attn: MCMR-JA (Ms. Arwine), 504 Scott Street, Ft. Detrick, MD, 21702, US

(21) Appl. No.: 09/812,271

(22) Filed: Mar. 19, 2001

(51) Int. Cl. G01F 1/05

(52) U.S. Cl. 73/861.79

(57) ABSTRACT

An apparatus for monitoring fluid intake includes a bladder having a known volume and capable of holding fluid, the bladder having a fill opening and an extraction opening; a first section of tubing connected to the extraction opening; a fluid monitoring unit having a downstream end and an upstream end, the first section of tubing being connected to the fluid monitoring unit at the downstream end; a check valve disposed at the upstream end of the fluid monitoring unit; a second section of tubing connected to the check valve; and a bite valve connected to an end of the second section of tubing.

### STATEMENT OF GOVERNMENT INTEREST

The invention described herein may be manufactured and used by or for the Government of the United States of America for government purposes without the payment of any royalties therefor.

### BACKGROUND OF THE INVENTION

The present invention relates in general to devices for monitoring fluid intake and in particular to devices for monitoring fluid intake in humans.

Personal management of fluid consumption is important in a wide variety of circumstances. A variety of physiologic and medical problems can arise with inappropriate fluid intake. For example, underhydration increases the risk of thermal and cardiovascular strain and heat illness, reduces heat tolerance, reduces aerobic exercise capacity and performance, and possibly increases risk of infection. Gross overdrinking can lead to hyponatremia (low blood sodium levels), or clinical problems in some patient groups such as those undergoing hemodialysis. In addition, fluid intake management takes on nutritional and clinical importance when water containing micronutrients such as salt, or macro-nutrients such as carbohydrates, are being consumed. The ability to titer or control the consumption of phamacologically active fluids to achieve a desired outcome could have significant clinical value. The invention described herein can be used to both quantify the amount and pattern of fluid intake and to promote appropriate fluid intake.

Currently, quantifying the pattern and amount of fluid consumed over time by an individual is typically a tedious and inaccurate process. One approach is to ask individuals to only drink from a given personal container, to keep track of fluid consumed from that container, and to carefully make logbook records of the date, time, and amount of liquid consumed. The volume consumed is derived by reading the liquid level from graduations on a fluid container before and after drinking and calculating the difference by mental arithmetic. This approach is difficult under low-light conditions, and incorrect logbook entries are common.

### SUMMARY OF THE INVENTION

An important object of the present invention is to provide a simple, personal fluid measurement system that accurately determines the amount and timing of the fluid intake by the user and displays the relationship of fluid consumed to pre-determined fluid requirements.

Another object of the invention is to accurately determine the fluid remaining in a container containing a known initial volume and to display that “fluid gage” information to the user.

Further objects, features and advantages of the invention will become apparent from the following detailed description taken in conjunction with the following drawing.

### BRIEF DESCRIPTION OF THE DRAWINGS

Throughout the Figures, reference numerals that are the same refer to the same features.

FIG. 1 is a schematic view of one embodiment of the invention.

FIG. 2 is an enlarged schematic view of the fluid monitoring unit of the embodiment of FIG. 1.

FIG. 3 is a schematic of a computer connection for the embodiment of FIG. 1.

FIG. 4 is a schematic of a fill sensor for the embodiment of FIG. 1.

FIG. 5 is a schematic view of a second embodiment of the invention.

FIG. 6 is an enlarged schematic view of the fluid monitoring unit of the embodiment of FIG. 5.

FIG. 7 is a schematic of a computer connection for the embodiment of FIG. 5.

### DETAILED DESCRIPTION OF THE PREFERRED EMBODIMENTS

The present invention, referred to as a Drink-O-Meter (DOM), is an electromechanical measurement system that accurately measures water or fluid consumed from a container or canteen by a user over a period of time. The consumption information may be compared to preset values of required water or fluid intake during each hour of a 24 hour period. These preset values of required water consumption can be input by the user and will be retained by the DOM until changed by the user.

The DOM performs a calculation to determine if the user is consuming the required amount of water (or other fluid) to satisfy the pre-selected hydration rate. Consumption information is imparted to the user by an indicator which may be, for example, a three-element light emitting diode (LED) visual display. The LED display may indicate whether the user is consuming (a) less than the required amount of water, (b) an acceptable amount of water, or (c) an excessive or wasteful amount of water. The DOM further has the capability of detecting when a drink is taken by the user. When a drink is taken, the time and the volume consumed is stored in a non-volatile memory. This information can later be downloaded for study or can immediately be used to supply consumption versus time information to personal and local area data networks.

In one aspect of the invention, the DOM is used with a container of a known volume. When used with a container of known volume, the DOM can determine the amount of water remaining in the container and display this information to the user through the indicator, such as the three element LED visual display. This information will inform the user if the container is, for example, full, 3/4 full, 1/2 full, 1/4 full or is less than 1/8 full.

In another aspect of the invention, the DOM can be used as a stand-alone “electromechanical straw” capable of monitoring fluid consumed from any container.

Some advantages and features of the invention include:

a) Accurate measurement of the date, time, and the volume of liquid consumed by the user;

b) The ability to store data related to the amount and timing of fluid consumption for later retrieval and evaluation;

c) When used in conjunction with a container of known volume, such as a canteen, an accurate display of the fluid remaining in the container can be provided; and

d) The device can be programmed to provide a visual, auditory, or tactile signal to indicate whether or not the user is under, meeting, or above a given schedule of fluid consumption.

FIG. 1 is a schematic view of one embodiment of the invention. As shown in FIG. 1, a DOM 10 includes a bladder 12 (such as a canteen bladder) having a known volume and capable of holding a fluid 14. The bladder 12 has a fill opening 16 and an extraction opening 18. A first section of tubing 20 is connected to the extraction opening 18. A fluid monitoring unit 22 has a downstream end 24 and an upstream end 26. The first section of tubing 20 is connected to the fluid monitoring unit 22 at the downstream end 24. A check valve 28 is disposed at the upstream end 26 of the fluid monitoring unit 22. A second section of tubing 30 is connected to the check valve 28. A bite valve 32 is connected to an end of the second section of tubing 30.

The bite valve 32 is placed in the users mouth so that the user can draw fluid 14 from the bladder 12. The bite valve 32 prevents fluid from inadvertently escaping the DOM 10. The check valve 28 only allows the flow of a fluid in one direction, i.e., from the bladder 12 through the fluid monitoring unit 22 and the check valve 28 and then to the user through the bite valve 32. The flow of the fluid in the opposite direction is prevented by the check valve 28.

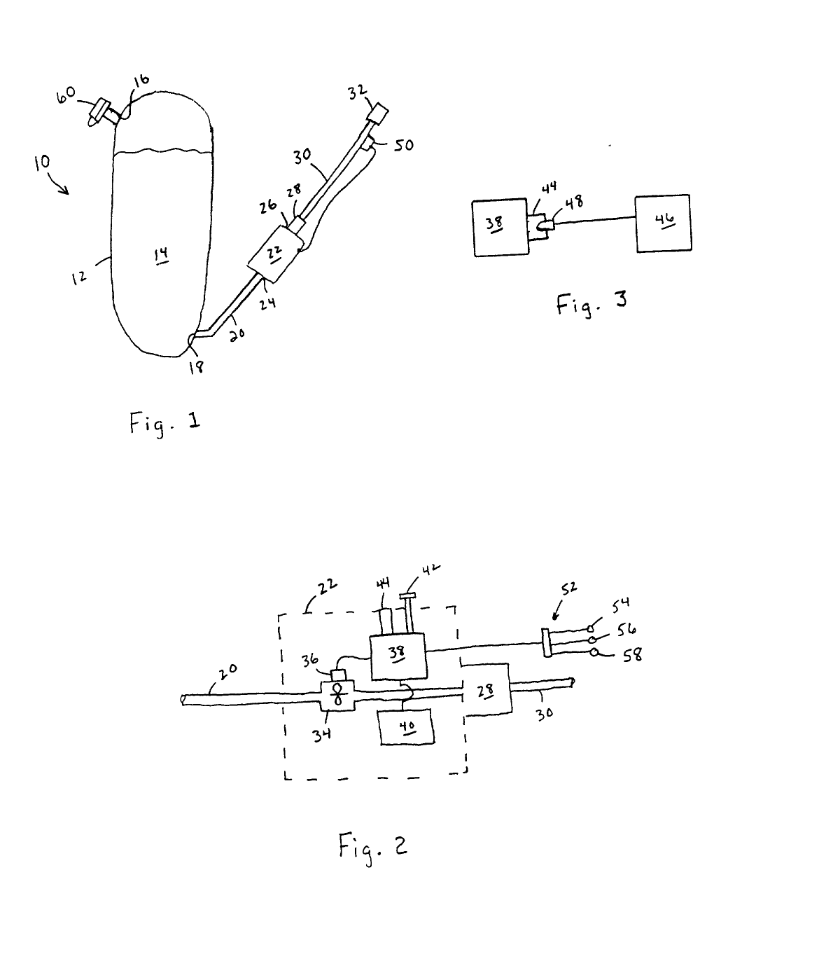

FIG. 2 is an enlarged schematic view of the fluid monitoring unit 22 of the DOM 10 of FIG. 1. As shown in FIG. 2, the fluid monitoring unit 22 includes a magnetic turbine flow sensor 34 disposed in the fluid flow path, a Hall effect sensor 36 for sensing rotation of the magnetic turbine flow sensor 34, a programmable microcontroller 38 connected to the Hall effect sensor 36 and a memory 40 connected to the programmable microcontroller 38.

As the fluid 14 is drawn through the magnetic turbine flow sensor 34, the enclosed turbine spins at a speed which is proportional to the flow of the fluid 14. Each time the turbine magnetic vane rotates past the Hall effect sensor 36, a pulse is produced by the Hall effect sensor which represents the flow of the liquid in, for example, milliliters. For example, one pulse may equal 0.1 milliliter.

The check valve 28 is an important feature of the invention. When the user draws some fluid 14 from the bladder 12, pulses representing the fluid flow are produced. Without the check valve 28, when the user is finished, fluid would flow back in the reverse direction through the magnetic turbine flow sensor 34. This reverse flow would yield inaccurate results because the turbine vane cannot differentiate between flow directions and reacts equally to flow in either direction. The check valve 28 inhibits this backflow problem and results in a highly accurate sensing system.

A communications jack 44, such as an RS-232 serial communications jack, is electrically connected to the programmable microcontroller 38. As shown in FIG. 3, the communications jack 44 permits communication between a computer 46, such as a PC, and the programmable microcontroller 38 via a communications plug 48, such as an RS-232 serial communications plug.

A normally open fluid reset switch 42 is connected to the programmable microcontroller As shown in FIG. 1, an indicator 50 is located on one of the first and second sections of the tubing 20, 30 and is connected to the programmable microcontroller 38. As shown in FIG. 2, the indicator 50 may be, for example, a light emitting diode (LED) display 52 having three LEDs 54, 56, 58. The LED display 52 is connected to the programmable microcontroller 38. The LED display 52 is preferably mounted on the second section of tubing 30 near the bite valve 32. In a preferred embodiment, the three LEDs 54, 56, 58 are colored green, yellow and red, respectively. The LEDs 54, 56, 58 may be arranged in a left to right arrangement of green, yellow and red when viewed from the user's perspective when the bite valve 32 is in the user's mouth. Alternatively, the indicator 50 may be a liquid crystal display or a tactile vibration signal.

As an example, one may assume that the bladder 12 has a capacity of 3000 milliliters. Upon the bladder 12 being filled with fluid 14, the user depresses the normally open fluid reset switch 42 momentarily. The normally open fluid reset switch 42 signals the programmable microcontroller 38 to set the fluid gage value to 3000 milliliters. When the DOM 10 is connected to the computer 46 by plugging the communications plug 48 into the communications jack 44 at power up, the DOM 10 will query the user for certain inputs. These inputs include:

1. Daily Hydration Rate. This is a single value to be entered and utilized in calculations to determine the Hydration Guidance.

2. Hourly Hydration Rate. The Hydration Rate is the rate of consumption of fluid that the user should be consuming as a function of time. For example, 200 milliliters per hour, etc. The Hourly Hydration Rate value allows a different value for each hour of a 24 hour period to be entered and utilized in calculations to determine the Hydration Guidance.

3. Selection of Hydration Guidance Display and/or Fluid Gage Display or neither.

When the user draws fluid 14 from the bladder 12, the Hall effect sensor 36 outputs a pulse count which is proportional to the fluid being consumed by the user. This pulse count is sent to the programmable microcontroller 38 and stored in the memory 40 for later downloading. The accumulated value of fluid consumed is also compared to the current required Hydration Rate. If the accumulated value is lower than the required Hydration Rate, the Green LED 54 will blink, if the value is equal to the required Hydration Rate, the Yellow LED 56 will blink. If the value is greater by a certain percentage of the required Hydration Rate, the Red LED 58 will blink. These LED indications signify to the user that he is under, meeting or exceeding the required fluid intake versus time.

The LEDs 54, 56, 58 may also display the volume of fluid 14 in the bladder 12 as follows. If the normally open fluid reset switch 42 has been depressed, the programmable microcontroller 38 has been signaled that the volume in the bladder 12 is 3000 milliliters, for example. Each time the user draws fluid from the bladder 12, the Hall effect sensor 36 outputs a series of pulses proportional to the amount of fluid 14 being consumed by the user. This amount of fluid is deducted from the initial 3000 milliliter value and the result displayed in the following manner. If the remaining volume is greater than 90% then the green LED 54 blinks. If the volume is greater than 75% and equal or less than 90%, then the green and yellow LEDs 54, 56 blink. If the volume is greater than 50% and equal or less than 75%, then the yellow LED 56 blinks. If the volume is greater than 25% and equal or less than 50%, then the yellow and red LEDs 56, 58 blink. If the volume is less than 10%, then the red LED 58 blinks. These percentage values and the blinking pattern of the LEDs are illustrative only and may be configured to any percentage values and a variety of blinking patterns.

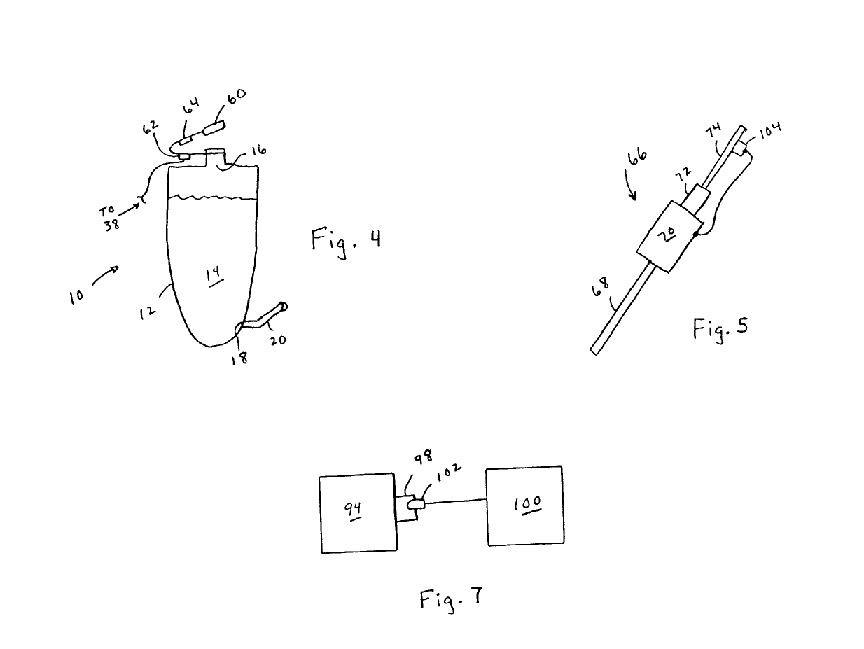

FIG. 4 shows a further feature of the DOM 10 in the form of an automatic fluid fill reset switch. As shown in FIG. 4, the DOM 10 includes a fill cap 60 for closing the fill opening 16, a reed switch 62 disposed at the fill opening 16 and connected to the programmable microcontroller 38 and a magnet 64 attached to the fill cap 60. The magnet 60 is disposed adjacent the reed switch 62 when the fill cap 60 is in a closed position.

When the fill cap 60 is removed to fill the bladder 12, the magnet 64 is moved away from the reed switch 62 thereby causing the reed switch 62 to open from its previous closed position. When the reed switch 62 opens, a signal is sent to the programmable microcontroller 38 indicating that the bladder 12 has been refilled. The programmable microcontroller 38 then resets its internal value to, for example, 3000 milliliters.

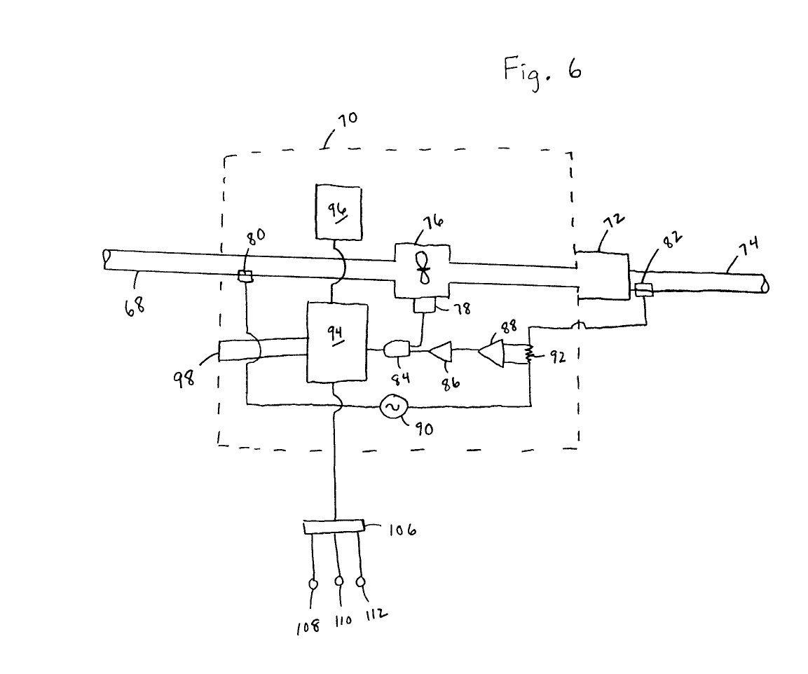

Another embodiment of the invention is shown in FIGS. 5-7. FIG. 5 is a schematic view of a DOM 66. The DOM 66 includes a first section of tubing 68 and a fluid monitoring unit 70 having a downstream end and an upstream end. The first section of tubing 68 is connected to the fluid monitoring unit 70 at the downstream end. A check valve 72 is disposed at the upstream end of the fluid monitoring unit 70. A second section of tubing 74 is connected to the check valve 72. The DOM 66 may be used with a variety of fluid filled containers to monitor the fluid intake of the user. The user inserts the first section of tubing 68 into a container and receives fluid from the end of the second section of tubing 74. The DOM 66 monitors the fluid intake of the user from each container in which the DOM 66 is inserted.

FIG. 6 is an enlarged schematic view of the fluid monitoring unit 70. The fluid monitoring unit 70 includes a magnetic turbine flow sensor 76 disposed in the fluid flow path, a Hall effect sensor 78 for sensing rotation of the magnetic turbine flow sensor 76 and an AND gate 84 having two inputs and an output. The Hall effect sensor 78 is connected to one input of the AND gate 84.

The fluid monitoring unit 70 further includes a first electrode 80 disposed in the first section of tubing 68 and a second electrode 82 disposed in the second section of tubing 74. Each of the electrodes 80, 82 is in contact with the fluid that flows past them and through the magnetic turbine flow sensor 76. The first and second electrodes 80, 82 are connected in series with an alternating voltage generator 90 and a resistor 92. An amplifier 88 is connected to ends of the resistor 92. A comparator 86 is connected to the output of the amplifier 88. The output of the comparator 86 is connected to the second input of the AND gate 84. A programmable microcontroller 94 is connected to the output of the AND gate 84 and a memory 96 is connected to the programmable microcontroller 94.

When a conductive fluid, such as water, flows through the magnetic turbine flow sensor 76 and, therefore, past and in contact with both electrode 80 and electrode 82, a small current will flow from one electrode, through the fluid, to the second electrode. This current will produce a small voltage drop across the resistor 92 that is in series with the electrodes 80, 82. The amplifier 88 amplifies the small voltage to a value large enough to trigger the voltage comparator 86 to a “High” state. If an interruption of fluid flow occurs between electrode 80 and electrode 82 because of air being in the flow path, the resistance between the electrodes will become almost infinite thereby causing no current to flow in the resistor 92. The voltage across the resistor 92 will immediately drop to zero. This voltage drop causes the comparator 86 to output a “Low” state.

The output of the comparator 86 is connected to one input of the two input AND gate 84 and the output of the Hall effect sensor 78 is connected to the second input of the two input AND gate 84. Therefore, the AND gate 84 will only output a valid count from the Hall effect sensor 78 when the output of the comparator 86 is “High”, thus signaling that an uninterrupted column of fluid is present between the two electrodes 80, 82. When air is present between the two electrodes, there is no voltage across resistor 92 which produces a “Low” output state of the comparator 86. The comparator 86 will then cause the AND gate 84 to inhibit any further counting of the Hall effect sensor 78 because the data is now invalid and inaccurate due to the air in the flow path. An accurate count of the Hall effect sensor 78 begins again upon detection of a continuous fluid flow.

The fluid monitoring unit 70 may also include a communications jack 98 connected to the programmable microcontroller 94. As shown in FIG. 7, a computer 100 having a communications plug 102 may be connected to the communications jack 98 of the programmable microcontroller 94 for inputting data as described above with respect to the embodiment of FIGS. 1-4. In the case of the DOM 66, because it may be used with a variety of containers, data related to the known volume of a container will not typically be necessary.

The DOM 66 may also include an indicator 104 (FIG. 5) located on one of the first and second section of tubing 68, 74 and connected to the programmable microcontroller 94. In a preferred embodiment, the indicator comprises an LED display 106 having three LEDs 108, 110, 112 (FIG. 6). The LED display 106 functions similar to the LED display 52, described above, except that indications of the amount of fluid remaining in a container of known volume will not normally be used. Alternatively, the indicator 104 may be a liquid crystal display or a tactile vibration signal.

While the invention has been described with reference to certain preferred embodiments, numerous changes, alterations and modifications to the described embodiments are possible without departing from the spirit and scope of the invention, as defined in the appended claims and equivalents thereof.

What is claimed is:

1. An apparatus for monitoring fluid intake, comprising:
a bladder having a known volume and capable of holding fluid, the bladder having a fill opening and an extraction opening;
a first section of tubing connected to the extraction opening;
a fluid monitoring unit having a downstream end and an upstream end, the first section of tubing being connected to the fluid monitoring unit at the downstream end;
a check valve disposed at the upstream end of the fluid monitoring unit;
a second section of tubing connected to the check valve; and
a bite valve connected to an end of the second section of tubing.

2. The apparatus of claim 1 wherein the fluid monitoring unit comprises a magnetic turbine flow sensor disposed in a fluid flow path, a Hall effect sensor for sensing rotation of the magnetic turbine flow sensor, a programmable microcontroller connected to the Hall-effect sensor and a memory connected to the programmable microcontroller.

3. The apparatus of claim 2 wherein the fluid monitoring unit comprises a normally open fluid reset switch connected to the programmable microcontroller.

4. The apparatus of claim 3 wherein the fluid monitoring unit comprises a communications jack connected to the programmable microcontroller.

5. The apparatus of claim 4 further comprising a computer and a communications plug connected to the computer wherein the communications plug is inserted in the communications jack of the programmable microcontroller.

6. The apparatus of claim 2 further comprising an indicator located on one of the first and second sections of tubing and connected to the programmable microcontroller.

7. The apparatus of claim 6 wherein the indicator comprises an LED display.

8. The apparatus of claim 2 further comprising a fill cap for closing the fill opening, a reed switch disposed at the fill opening and connected to the programmable microcontroller and a magnet attached to the fill cap and disposed adjacent the reed switch when the fill cap is in a closed position.

9. An apparatus for monitoring fluid intake, comprising:
a first section of tubing;
a fluid monitoring unit having a downstream end and an upstream end, the first section of tubing being connected to the fluid monitoring unit at the downstream end;
a check valve disposed at the upstream end of the fluid monitoring unit; and
a second section of tubing connected to the check valve.

10. The apparatus of claim 9 wherein the fluid monitoring unit comprises:
a magnetic turbine flow sensor disposed in a fluid flow path;
a Hall effect sensor for sensing rotation of the magnetic turbine flow sensor;
an AND gate having two inputs and an output, the Hall effect sensor being connected to one input of the AND gate;
a first electrode disposed in the first section of tubing and a second electrode disposed in the second section of tubing, the first and second electrodes being connected in series with an alternating voltage generator and a resistor;
an amplifier connected to ends of the resistor;
a comparator connected to an output of the amplifier, an output of the comparator being connected to the other input of the AND gate;
a programmable microcontroller connected to the output of the AND gate; and
a memory connected to the programmable microcontroller.

11. The apparatus of claim 10 wherein the fluid monitoring unit comprises a communications jack connected to the programmable microcontroller.

12. The apparatus of claim 11 further comprising a computer and a communications plug connected to the computer wherein the communications plug is inserted in the communications jack of the programmable microcontroller.

13. The apparatus of claim 10 further comprising an indicator located on one of the first and second section of tubing and connected to the programmable microcontroller.

14. The apparatus of claim 13 wherein the indicator comprises an LED display.
